(19) United States
(12) Patent Application Publication
(10) Pub. No.: US 2025/0091061 A1
(43) Pub. Date: Mar. 20, 2025

(54) WATER SPINNER STRUCTURE

(71) Applicant: NINGBO AMI GARDEN TOOLS INDUSTRY CO.,LTD., Ningbo City (CN)

(72) Inventor: Lifeng Xu, Ningbo City (CN)

(21) Appl. No.: 18/962,889

(22) Filed: Nov. 27, 2024

(30) Foreign Application Priority Data
Nov. 28, 2023 (CN) 202323226892.0

(51) Int. Cl. B05B 3/04; B05B 15/74

(52) U.S. Cl. CPC B05B 3/0477; B05B 15/74

(57) ABSTRACT

The invention discloses a water spinner structure, where a water inlet member and a water outlet pipe are connected to a driving mechanism; a driving assembly includes a driving member, an impeller is movably connected to the driving member, a first and second impeller driving channel are provided on the driving member, and after water flows into the water inlet member, the impeller is driven to rotate in a first direction through the first impeller driving channel to drive the driving mechanism to rotate to make the water outlet pipe rotate in a circumferential direction, or after water flows into the water inlet member, the impeller is driven to rotate in a second direction through the second impeller driving channel to drive the driving mechanism to rotate to make the water outlet pipe rotate in the circumferential direction, so as to switch the rotation direction of the water outlet pipe.

### TECHNICAL FIELD

The present invention relates to the technical field of water spraying devices, and in particular relates to a water spinner structure.

### BACKGROUND

Lawn refers to the grassland that is artificially planted or maintained and managed for greening and beautification purposes. The lawn is covered with grass and other fine plants of the Gramineae, and filled with their roots and stolon on the soil surface. The lawn is suitable for beautifying the environment, landscaping, purifying the air, maintaining the soil and water, providing outdoor activities and sports venues. The lawn needs to be irrigated frequently during maintenance. Nowadays, most garden lawns are automatically watered by sprinklers. In the process of watering the garden lawn, due to the fixed lift of the existing sprinkler in the process of spraying water, it is easy to form water accumulation around the lawn, resulting in waste of water resources, so it is very important to obtain a rotary water spinner structure.

### SUMMARY

In order to solve at least one of the above technical problems, the present invention provides a water spinner structure, including a driving mechanism, where the driving mechanism includes a driving assembly, and a water inlet member and a water outlet pipe are connected to the driving mechanism.

The driving assembly includes a driving member, an impeller is movably connected to the driving member, a first impeller driving channel is provided on the driving member, and after water flows into the water inlet member, the impeller is driven to rotate in a first direction through the first impeller driving channel to drive the driving mechanism to rotate to make the water outlet pipe rotate in a circumferential direction. A water outlet is provided on the driving member; a limiting upright post is respectively fixed at both sides of the water outlet; the water spinner structure further includes a plug body, and a first spring is mounted between the plug body and a housing, so that the plug body moves within the range of the limiting upright post to open or close a water outlet channel, and the spring is arranged to not act at a low pressure and act at a high pressure, that is, the channel is opened. In this way, a substantially constant pressure can be established, and finally a substantially constant swinging speed at high and low water pressures can be achieved, and there will be no slow swing at the low pressure and fast swing at the high pressure.

A second impeller driving channel is further provided on the driving member, and after water flows into the water inlet member, the impeller is driven to rotate in a second direction through the second impeller driving channel to drive the driving mechanism to rotate to make the outlet pipe rotate in the circumferential direction; and the water spinner structure further includes a channel reversing mechanism to control the water to pass through the second impeller driving channel or the first impeller driving channel.

With the technical solution described above, the second impeller driving channel is added, so that the water outlet pipe can rotate in two directions, and the rotation direction can be automatically switched when rotating.

As a preferred embodiment of the above technical solution, the channel reversing mechanism includes channel changeover plates connected to the driving mechanism by a reversing rotating shaft, and both sides of the channel changeover plate located on both sides of the reversing rotating shaft respectively form a cover plate controlling the first impeller driving channel to be blocked and the second impeller driving channel to be opened or the first impeller driving channel to be opened and the second impeller driving channel to be blocked.

With the technical solution described above, the channel reversing mechanism is arranged to enable the channel to be reversed, thus realizing reciprocating swing rotation of the water outlet pipe to spray water.

As a preferred embodiment of the above technical solution, the driving assembly further includes a gear transmission mechanism, the gear transmission mechanism is meshed with the water inlet member, and the gear transmission mechanism drives the impeller to rotate, and the water inlet member is fixedly connected with the driving member. The impeller passes through the driving member and is meshed with the gear transmission mechanism. The water inlet member is formed with an insert, and the driving member is provided with an insertion post matched with the insert.

The channel reversing mechanism further includes a reversing control mechanism, the reversing control mechanism includes a first reversing rod, the first reversing rod includes a first rod body, a spring and a second rod body, the spring connects the first rod body and the second rod body, and the second rod body is arranged on the channel changeover plate. End portions of the first rod body and the second rod body are inserted into both ends of the spring. A spherical surface is provided outside the first rod body, an outer diameter of the spherical surface is greater than an outer diameter of the first rod body, and the first rod body is sheathed with a seal ring at a position close to the spherical surface.

With the technical solution described above, the spring connects the first rod body and the second rod body, so that when the first rod body is subject to a reversing resistance, a toggling force is transmitted to the second rod body by the spring to achieve reversing.

Compared with the prior art, the present invention has the following advantages: the present invention has a simple structure, in which the impeller is driven by water flow and water pressure, the impeller is driven to drive the water outlet pipe to rotate and spray water, the driving member is added to drive the reversing mechanism after the water outlet pipe rotates by a certain angle, and the first impeller driving channel or the second impeller driving channel on the driving member is switched to switch the rotation direction to realize reciprocal work, and an angle of rotation of the water outlet pipe is adjusted through limiting adjustment by an angle adjustment mechanism to realize the use in multiple ranges of angle. The present invention also has the advantages of long service life, good reciprocating water spraying effect, convenient and quick use, good stability and the like.

### BRIEF DESCRIPTION OF THE DRAWINGS

FIG. 1 is a sectional perspective view (partially enlarged view) of the present invention;

FIG. 2 is a first schematic diagram of a partial structure of the present invention;

FIG. 3 is a second schematic diagram of a partial structure of the present invention;

FIG. 4 is a structural exploded view of a first reversing rod of the present invention;

FIG. 5 is a perspective view of a driving mechanism on a driving member of the present invention;

FIG. 6 is a structural schematic diagram of a gear transmission mechanism, a water inlet member and a driving member cooperating with each other;

FIG. 7 is a structural perspective view of a water inlet member;

FIG. 8 is an assembly perspective view of an angle adjustment mechanism;

FIG. 9 is a perspective view of another reversing control mechanism;

FIG. 10 is a partial perspective view of a reversing control mechanism of the present invention;

FIG. 11 is a top view of a driving member of the present invention; and

FIG. 12 is a perspective view of the driving member of the present invention.

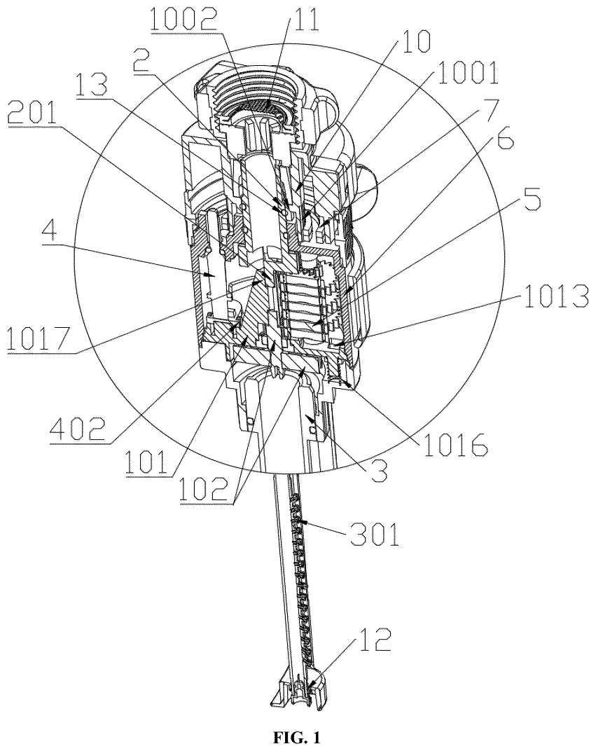

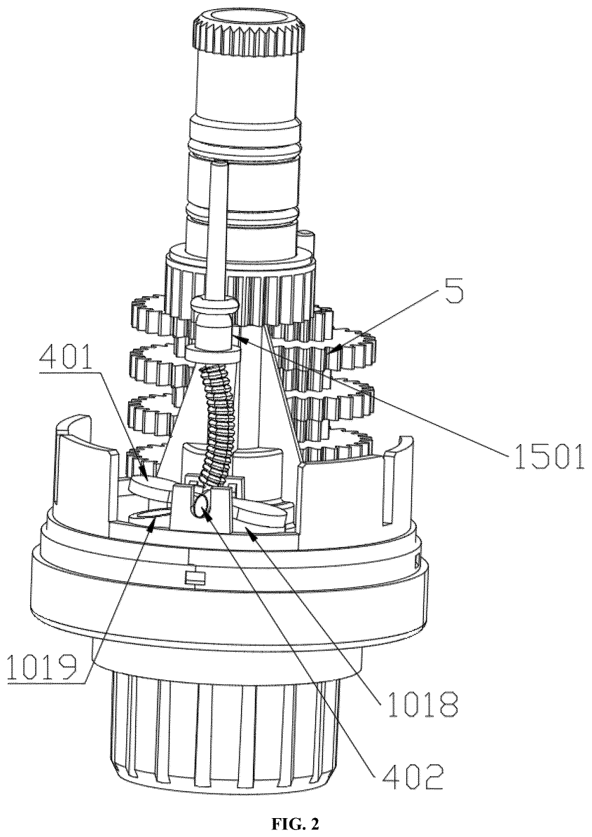

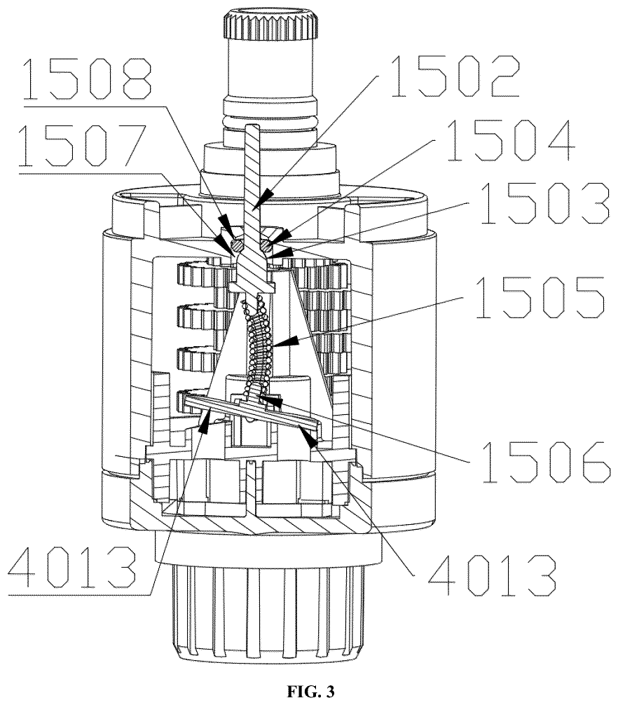

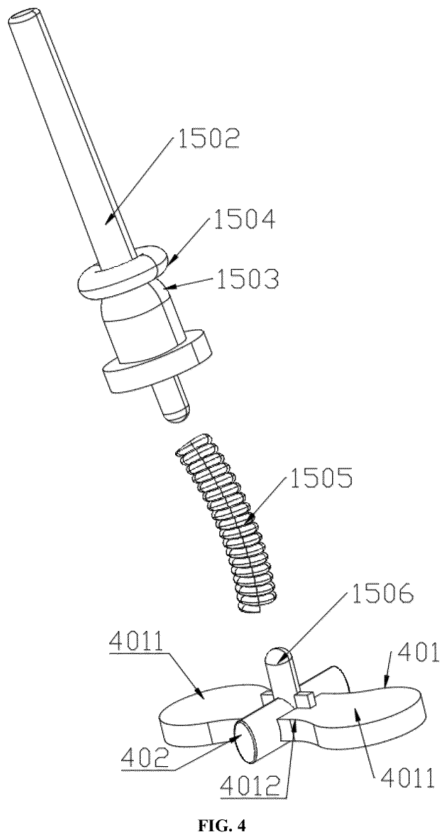

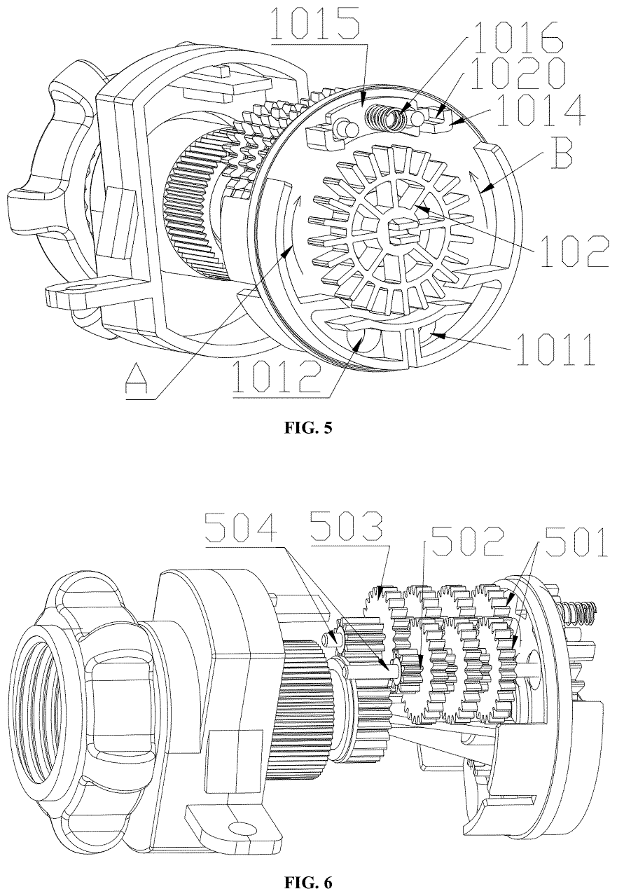

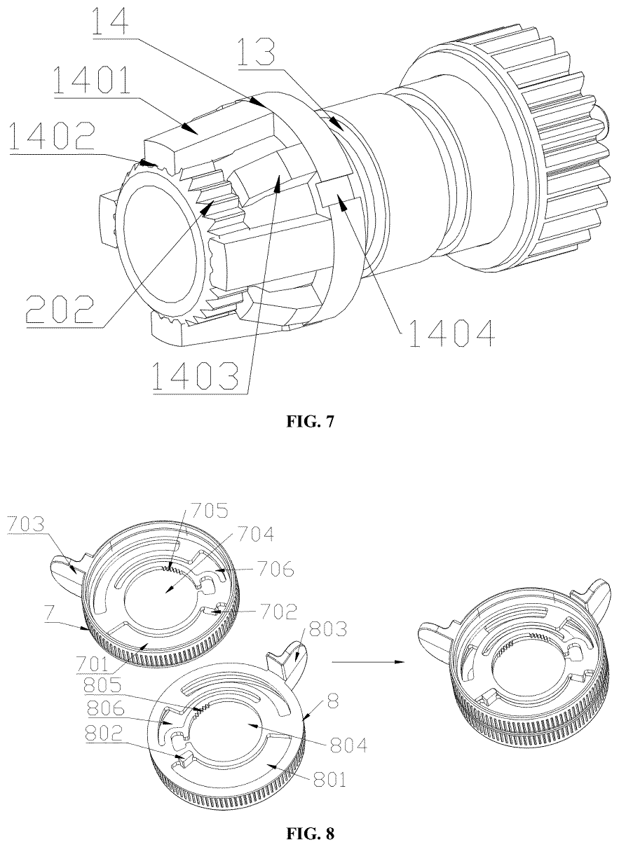

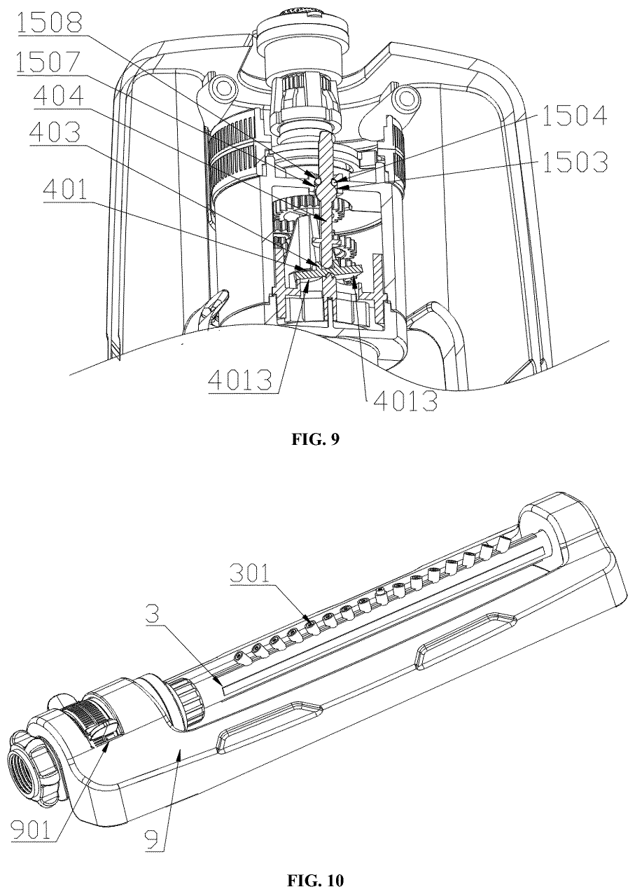

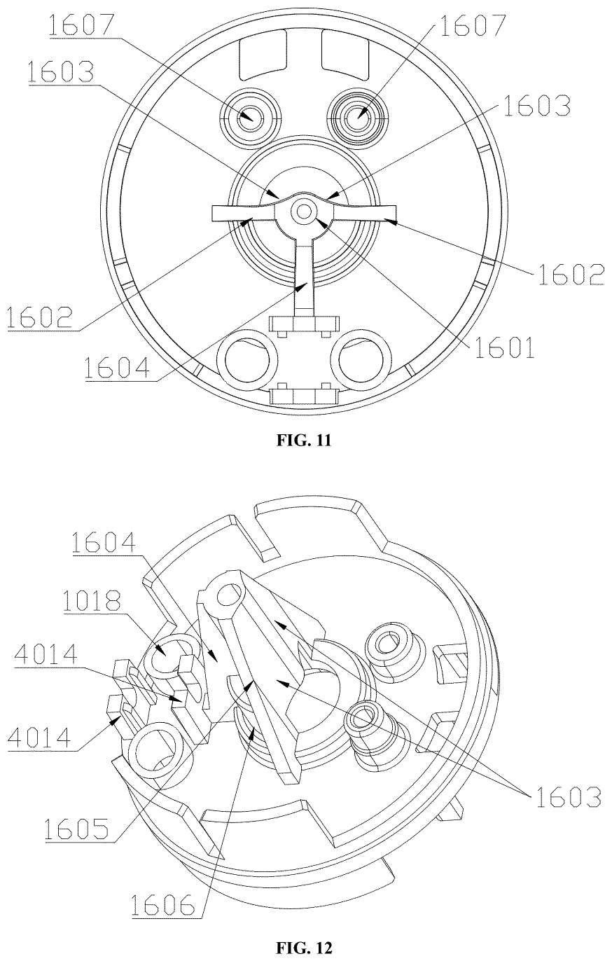

Reference numerals: 101 driving member; 1011 first impeller driving channel; 1012 second impeller driving channel; 1013 water outlet; 1014 limiting upright post; 1015 plug body; 1016 first spring; 1017 insertion post; 1018 extended convex ring; 1019 first inclined plane; 1020 guide groove; 102 impeller; 2 water inlet member; 201 insert; 202 fourth limiting tooth; 3 water outlet pipe; 301 water outlet hole; 4 channel reversing mechanism; 401 channel changeover plate; 4011 circular plugging plate; 4012 arc surface; 402 reversing rotating shaft; 4013 cover plate; 4014 rotating bracket; 403 reversing projection; 404 second reversing rod; 5 gear transmission mechanism; 501 gear set; 502 pinion; 503 gearwheel; 504 rotating shaft; 6 housing; 7 first direction adjustment member; 701 first track; 702 first anti-drop block; 703 first limiting member; 704 first perforation; 705 second limiting tooth; 706 first hollow; 8 second direction adjustment member; 801 second track; 802 second anti-drop block; 803 second limiting member; 804 second perforation; 805 third limiting tooth; 806 second hollow; 9 base; 901 opening; 10 adjustment member; 1001 first limiting tooth; 1002 strip-shaped insert; 11 filter screen structure; 12 bearing; 13 sealing ring; 14 holddown member; 1401 holddown arm; 1402 fifth limiting tooth; 1403 embracing member; 1404 strip-shaped slot; 1501 first reversing rod; 1502 first rod body; 1503 spherical surface; 1504 seal ring; 1505 second spring; 1506 second rod body; 1507 through hole; 1508 annular step; 1601 support bracket; 1602 first support plate; 1603 circular arc surface; 1604 second support plate; 1605 second inclined plane; and 1606 step surface.

### DESCRIPTION OF THE EMBODIMENTS

In order to make those skilled in the art better understand the present invention and thereby define the scope of the present invention more clearly, the present invention is described below in detail with respect to some specific embodiments of the present invention. It should be noted that the following description only relates to some specific embodiments of the inventive concept and are only part of the embodiments of the present invention, specific and direct descriptions of relevant structures are merely for the convenience of understanding the present invention, and the specific features do not, of course, directly limit the implementation scope of the present invention.

With reference to the drawings, the present invention adopts the following technical solution: a water spinner structure, includes a driving mechanism, the driving mechanism includes a driving assembly, and a water inlet member 2 and a water outlet pipe 3 are connected to the driving mechanism.

The driving assembly includes a driving member 101, an impeller 102 is movably connected to the driving member 101, a first impeller driving channel 1011 is provided on the driving member 101, and after water flows into the water inlet member 2, the impeller 102 is driven to rotate in a first direction A through the first impeller driving channel 1011 to drive the driving mechanism to rotate to make the water outlet pipe 3 rotate in a circumferential direction. A water outlet 1013 is provided on the driving member 101; a limiting upright post 1014 is respectively fixed at both sides of the water outlet 1013; the water spinner structure further includes a plug body 1015, and a first spring 1016 is mounted between the plug body 1015 and a housing 6, so that the plug body 1015 moves within the range of the limiting upright post 1014 to open or close the water outlet 1013, an end portion of the plug body 1015 is located in a guide groove 1020 of the limiting upright post 1014 stabilize displacement of the plug body 1015, and the first spring 1016 is arranged to not act at a low pressure and act at a high pressure, that is, the channel is opened. In this way, a substantially constant pressure can be established, and finally a substantially constant swinging speed at high and low water pressures can be achieved, and there will be no slow swing at the low pressure and fast swing at the high pressure.

A second impeller driving channel 1012 is further provided on the driving member 101, and after water flows into the water inlet member 2, the impeller 102 is driven to rotate in a second direction B through the second impeller driving channel 1012 to drive the driving mechanism to rotate to make the outlet pipe 3 rotate in the circumferential direction; and the water spinner structure further includes a channel reversing mechanism 4 to control the water to pass through the second impeller driving channel 1012 or the first impeller driving channel 1011. The second impeller driving channel 1012 is added, so that the water outlet pipe 3 can rotate in two directions, and the rotation mode of the water outlet pipe 3 can be automatically switched.

As a preferred embodiment of the above technical solution, the channel reversing mechanism 4 includes channel changeover plates 401 connected to the driving mechanism by a reversing rotating shaft 402, and both sides of the channel changeover plate 401 located on both sides of the reversing rotating shaft 402 respectively form a cover plate 4013 controlling the first impeller driving channel 1011 to be blocked and the second impeller driving channel 1012 to be opened or the first impeller driving channel 1011 to be opened and the second impeller driving channel 1012 to be blocked. The channel reversing mechanism 4 is arranged to enable the channel to be reversed, thus realizing reciprocating swing rotation of the water outlet pipe 3 to spray water, and the reversing rotating shaft 402 is circular.

As a preferred embodiment of the above technical solution, the driving assembly further includes a gear transmission mechanism 5, the gear transmission mechanism 5 is meshed with the water inlet member 2, and the gear transmission mechanism 5 drives the impeller 102 to rotate, and the water inlet member 2 is fixedly connected with the driving member 101. The impeller 102 passes through the driving member 101 and is meshed with the gear transmission mechanism 5. The water inlet member 2 is formed with an insert 201, and the driving member 101 is provided with an insert post 1017 matched with the insert 201.

As a preferred embodiment of the above technical solution, the channel reversing mechanism 4 further includes a reversing control mechanism, the reversing control mechanism includes a first reversing rod 1501, the first reversing rod 1501 includes a first rod body 1502, a second spring 1505 and a second rod body 1506, the second spring 1505 connects the first rod body 1502 and the second rod body 1506, and the second rod body 1506 is arranged on the channel changeover plate 401. End portions of the first rod body 1502 and the second rod body 1506 are inserted into both ends of the second spring 1505; a spherical surface 1503 is provided outside the first rod body 1502, a seal ring 1504 is sheathed on the spherical surface 1503, an upper end of the second rod body 1506 passes through a through hole 1507 of the housing 6, and the spherical surface 1503 is clamped onto an annular step 1508 of the through hole 1507 of the housing 6 by the seal ring 1504. With the technical solution described above, the second spring 1505 cooperates with the first rod body 1502 and the second rod body 1506, so that when the first rod body 1502 is subject to a reversing resistance, a toggling force is can be generated and transmitted to the second rod body 1506 by the second spring 1505 to achieve reversing. Or

[symbol]

The channel reversing mechanism 4 further includes a reversing control mechanism; the reversing control mechanism includes two reversing projections 403 provided on the channel changeover plate 401, and further includes a second reversing rod 404; the driving mechanism includes a housing 6; one end of the second reversing rod 404 is arranged between the two reversing projections 403; and the second reversing rod 404 passes through the housing 6. The gear transmission mechanism 5 includes two gear sets 501, each of the gear sets 501 includes a pinion 502 and a gearwheel 503 spaced apart, the gearwheel 503 of one gear set 501 is meshed with the pinion 502 of the other gear set 501, and the pinion 502 of one gear set 501 is meshed with the gearwheel 503 of the other gear set 501. The driving member 101 is fixed in the housing 6, a rotating shaft 504 is connected between the driving member 101 and the housing 6, and the gear set 501 is sheathed on the rotating shaft 504; a spherical surface 1503 is provided outside the second reversing rod 404, an outer diameter of the spherical surface 1503 is greater than an outer diameter of the second reversing rod 404, the second reversing rod 404 is sheathed with a seal ring 1504 at a position close to the spherical surface 1503, an upper end of the second reversing rod 404 passes through the through hole 1507 of the housing 6, and the spherical surface 1503 is clamped onto the annular step 1508 of the through hole 1507 of the housing 6 by the seal ring 1504. An end portion of the second reversing rod 404 is wedge-shaped to facilitate reversing operation.

Based on the above, the end pinion 502 of one gear set 501 is meshed with a gear on the fixedly arranged water inlet member 2, and one end of the water inlet member 2 is rotatably connected in a connection hole of the housing 6 and is sealed with each other by a sealing ring 13, so that when the impeller 102 rotates, the end pinion 502 of one gear set 501 rotates by means of meshing transmission of the two gear sets 501, causing the end pinion 502 of one gear set 501 to make a circular motion around the gear on the water inlet member 2, causing the housing 6 to rotate.

As a preferred embodiment of the above technical solution, the water spinner structure includes an angle adjustment mechanism, the angle adjustment mechanism includes a first direction adjustment member 7 and a second direction adjustment member 8, a first track 701 is provided on the first direction adjustment member 7, a second track 801 is provided on the second direction adjustment member 8, and an overlapping portion of the first track 701 and the second track 801 forms a movable range of the first reversing rod 1501 or the second reversing rod 404.

As a preferred embodiment of the above technical solution, a first anti-drop block 702 matched with an inner wall of the second track 801 is formed on the first track 701, and a second anti-drop block 802 matched with an inner wall of the first track 701 is formed on the second track 801.

As a preferred embodiment of the above technical solution, the water spinner structure further includes a base 9, an adjustment member 10 is fixed on the base 9, a first limiting tooth 1001 is provided on an outer wall of the adjustment member 10, a first limiting member 703 is fixed on the first direction adjustment member 7, a second limiting member 803 is fixed on the second direction adjustment member 8, and an opening 901 for adjusting the first limiting member 703 and the second limiting member 803 is provided on the base 9; a first perforation 704 is formed on the first direction adjustment member 7, and a second limiting tooth 705 matched with the first limiting tooth 1001 is provided on an inner wall of the first perforation 704; and a second perforation 804 is formed on the second direction adjustment member 8, and a third limiting tooth 805 matched with the first limiting tooth 1001 is provided on an inner wall of the second perforation 804. A first hollow 706 is provided outside the first perforation 704 so that the first perforation 704 forms an elastic arm structure; and a second hollow 806 is formed outside the second perforation 804 so that the second perforation 804 forms an elastic arm structure. The housing 6 is rotatably connected with the adjustment member 10. A water inlet pipe is connected to the adjustment member 10, and a filter screen structure 11 is fixedly connected to the water inlet pipe.

A bearing 12 is connected between the water outlet pipe 3 and the base 9.

The sealing ring 13 is arranged between the water inlet member 2 and the adjustment member 10 which are connected by a holddown member 14, a holddown arm 1401 is fixed on the holddown member 14, a fourth limiting tooth 202 is provided on the water inlet member 2, a fifth limiting tooth 1402 matched with the fourth limiting tooth 202 is provided on the holddown arm 1401, an embracing member 1403 is fixed between adjacent holddown arms 1401, and the embracing member 1403 abuts against an outer wall of the driving member 101.

A strip-shaped insert 1002 is provided on an inner wall of the adjustment member 10, and a strip-shaped slot 1404 for matching the strip-shaped insert 1002 is provided on an outer wall of the holddown member 14.

As a preferred embodiment of the above technical solution, the water outlet pipe 3 is linear, and at least one water outlet hole 301 is provided on the water outlet pipe 3. The water outlet holes 301 are arranged obliquely with respect to the water outlet pipe 3 from the middle to both sides, and an inclination angle increases successively.

The water outlet holes 301 are arranged obliquely with respect to the water outlet pipe 3 from the middle to both sides, and an inclination angle increases successively, which can increase the coverage of the water outlet holes.

The two cover plates 4013 of the channel changeover plate 401 are respectively circular plugging plates 4011, and the two circular plugging plates 4011 are connected to each other by the transition of an arc surface 4012 to form a “8” shape. The driving member 101 is provided with two spaced-apart rotating brackets 4014 matched with the reversing rotating shaft 402. An extended convex ring 1018 is formed at the second impeller driving channel 1012 and the first impeller driving channel 1011, and a surface of the extended convex ring 1018 forms a first inclined plane 1019 matched with the circular plugging plate 4011. The reversing rotating shaft 402 is elliptical.

A support bracket 1601 is provided on the driving member 101, the support bracket 1601 includes at least two first support plates 1602, a circular arc surface 1603 is provided on the first support plate 1602, and a mounting space for accommodating the gear transmission mechanism 5 is formed between an outer side of the circular arc surface 1603 and an inner wall of the housing 6. The support bracket 1601 further includes a second support plate 1604, an included angle between the two first support plates 1602 is 180 degrees, the second support plate 1604 is arranged between the two first support plates 1602, and a second inclined plane 1605 is provided on the first support plate 1602 and the second support plate 1604. A bottom surface of the driving member is provided with a step surface 1606 toward a top side of the support bracket 1601.

With the technical solution described above, arranging the circular arc surface 1603 on the first support plate 1602 enables reasonable space allocation, which further facilitates mounting of the gear transmission mechanism 5.

Compared with the prior art, the present invention has the following advantages: the present invention has a simple structure, in which the impeller 102 is driven by water flow and water pressure, the impeller 102 is driven to drive the water outlet pipe 3 to rotate and spray water, the driving member 101 is added to drive the reversing mechanism after the water outlet pipe 3 rotates by a certain angle, and the first impeller driving channel 1011 or the second impeller driving channel 1012 on the driving member 101 is switched to change the rotation direction to realize reciprocal work, and the angle of rotation of the water outlet pipe 3 is adjusted through limiting adjustment by an angle adjustment mechanism to realize the use in multiple ranges of angle. The present invention also has the advantages of long service life, good reciprocating water spraying effect, convenient and quick use, good stability and the like.

The above description is not intended to limit the present invention, and the present invention is not limited to the above examples. Any changes, modifications, additions or substitutions made by those skilled in the art within the scope of the present invention shall all belong to protection scope of the present invention.

What is claimed is:

1. A water spinner structure, comprising a driving mechanism, the driving mechanism comprising a driving assembly, and a water inlet member and a water outlet pipe being connected to the driving mechanism; wherein
the driving assembly comprises a driving member, an impeller is movably connected to the driving member, a first impeller driving channel is provided on the driving member, and after water flows into the water inlet member, the impeller is driven to rotate in a first direction through the first impeller driving channel to drive the driving mechanism to rotate to make the water outlet pipe rotate in a circumferential direction.

2. The water spinner structure according to claim 1, wherein a second impeller driving channel is further provided on the driving member, and after water flows into the water inlet member, the impeller is driven to rotate in a second direction through the second impeller driving channel to drive the driving mechanism to rotate to make the outlet pipe rotate in the circumferential direction; and the water spinner structure further comprises a channel reversing mechanism to control the water to pass through the second impeller driving channel or the first impeller driving channel.

3. The water spinner structure according to claim 2, wherein the channel reversing mechanism comprises channel changeover plates connected to the driving mechanism by a reversing rotating shaft, and both sides of the channel changeover plate located on both sides of the reversing rotating shaft respectively form a cover plate controlling the first impeller driving channel to be blocked and the second impeller driving channel to be opened or the first impeller driving channel to be opened and the second impeller driving channel to be blocked.

4. The water spinner structure according to claim 2, wherein the driving assembly further comprises a gear transmission mechanism, the gear transmission mechanism is meshed with the water inlet member, and the gear transmission mechanism drives the impeller to rotate, and the water inlet member is fixedly connected with the driving member.

5. The water spinner structure according to claim 3, wherein the channel reversing mechanism further comprises a reversing control mechanism, the reversing control mechanism comprises a first reversing rod, the driving mechanism comprises a housing, the first reversing rod comprises a first rod body, a second spring and a second rod body, the second spring connects the first rod body and the second rod body, the second rod body is arranged on the channel changeover plate, and an upper end of the second rod body passes through the housing.

6. The water spinner structure according to claim 3, wherein the channel reversing mechanism further comprises a reversing control mechanism; the reversing control mechanism comprises two reversing projections provided on the channel changeover plate, and further comprises a second reversing rod; the driving mechanism comprises a housing; one end of the second reversing rod is arranged between the two reversing projections; and an upper end of the second reversing rod passes through the housing.

7. The water spinner structure according to claim 5, wherein end portions of the first rod body and the second rod body are inserted into both ends of the second spring.

8. The water spinner structure according to claim 3, wherein a spherical surface is provided outside the first rod body, an outer diameter of the spherical surface is greater than an outer diameter of the first rod body, and the first rod body is sheathed with a seal ring at a position close to the spherical surface.

9. The water spinner structure according to claim 5, wherein the two cover plates of the channel changeover plate are respectively circular plugging plates, and the two circular plugging plates are connected to each other by the transition of an arc surface to form an “8” shape.

10. The water spinner structure according to claim 3, wherein the reversing rotating shaft is arranged in the middle of the channel changeover plate, and the driving member is provided with a rotating bracket matched with the reversing rotating shaft.

11. The water spinner structure according to claim 10, wherein an extended convex ring is formed at the second impeller driving channel and the first impeller driving channel, and a surface of the extended convex ring forms a first inclined plane matched with the circular plugging plate.

12. The water spinner structure according to claim 3, wherein the water spinner structure further comprises a plug body, a water outlet is provided on the driving member, a limiting upright post is respectively fixed at both sides of the water outlet, a first spring is mounted between the plug body and the housing, so that the plug body moves within the range of the limiting upright post to open and close the water outlet, and an end portion of the plug body is located in a guide groove of the limiting upright post.

13. The water spinner structure according to claim 4, wherein a support bracket is provided on the driving member, the support bracket comprises at least two first support plates, a circular arc surface is provided on the first support plate, and a mounting space for accommodating the gear transmission mechanism is formed between an outer side of the circular arc surface and an inner wall of the housing.

14. The water spinner structure according to claim 13, wherein the support bracket further comprises a second support plate, an included angle between the two first support plates is 180 degrees, the second support plate is arranged between the two first support plates, and a second inclined plane is provided on the first support plate and the second support plate.

15. The water spinner structure according to claim 13, wherein a bottom surface of the driving member is provided with a step surface toward a top side of the support bracket.

16. The water spinner structure according to claim 5, wherein the gear transmission mechanism comprises two gear sets, each of the gear sets comprises a pinion and a gearwheel spaced apart, the gearwheel of one gear set is meshed with the pinion of the other gear set, and the pinion of one gear set is meshed with the gearwheel of the other gear set.

17. The water spinner structure according to claim 5, wherein the water spinner structure further comprises an angle adjustment mechanism, the angle adjustment mechanism comprises a first direction adjustment member and a second direction adjustment member, a first track is provided on the first direction adjustment member, a second track is provided on the second direction adjustment member, and an overlapping portion of the first track and the second track forms a movable range of the second reversing rod.

18. The water spinner structure according to claim 17, wherein a first anti-drop block matched with an inner wall of the second track is formed on the first track, and a second anti-drop block matched with an inner wall of the first track is formed on the second track.

19. The water spinner structure according to claim 17, wherein the water spinner structure further comprises a base, an adjustment member is fixed on the base, a first limiting tooth is provided on an outer wall of the adjustment member, a first limiting member is fixed on the first direction adjustment member, a second limiting member is fixed on the second direction adjustment member, and an opening for adjusting the first limiting member and the second limiting member is provided on the base; a first perforation is formed on the first direction adjustment member, and a second limiting tooth matched with the first limiting tooth is provided on an inner wall of the first perforation; and a second perforation is formed on the second direction adjustment member, and a third limiting tooth matched with the first limiting tooth is provided on an inner wall of the second perforation.

20. The water spinner structure according to claim 1, wherein the water outlet pipe is linear, and at least one water outlet hole is provided on the water outlet pipe; and the water outlet holes are arranged obliquely with respect to the water outlet pipe from the middle to both sides, and an inclination angle increases successively.
